(19) United States
(12) Patent Application Publication
(10) Pub. No.: US 2002/0032645 A1
(43) Pub. Date: Mar. 14, 2002

(54) System and method for score calculation

(76) Inventors: Ken Nozaki, Machida (JP); Hiroshi Yoshikawa, Yokohama (JP); Tetsuya Maruoka, Kawasaki (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/764,073

(22) Filed: Jan. 19, 2001

(30) Foreign Application Priority Data
Sep. 13, 2000 (JP) 2000-283779

(51) Int. Cl. G06F 17/60

(52) U.S. Cl. 705/38; 705/10

(57) ABSTRACT

In a method of calculating a score using data, a plurality of layers are disposed and a prediction model is prepared for each of the layers to calculate a feature. According to a prediction model in a first layer, an output value is calculated using input data including at least one attribute selected from attributes of the data. Thereafter, a prediction model in a subsequent layer is selected according to the output value. The output value calculation and the subsequent layer prediction model selection are repetitiously conducted until a prediction model of a final layer is reached. A score is calculated using the prediction model in the final model.

### BACKGROUND OF THE INVENTION

The present invention relates to a method of and a system for calculating scores to order customers according to customer data, and in particular, to a method of and a system for changing a score calculation method according to customer data.

In fields of distribution and finance, customer attribute information items such as “age”, “sex”, and “address” of each customer and customer behavior information items such as “item purchase history” and “item payment history” have been accumulated in a customer database. Data of the information in the database is used to calculate scores representing conditions and statuses of customers. According to the scores, activities of marketing and application decision are carried out.

“Introduction To Credit Scoring” (ISBN 9995642239) describes a method of calculating scores using score cards. For each attribute of customer data, a plurality of categories are prepared and a score is assigned to each category. When customer data is obtained, a pertinent category is selected for each attribute of the customer data. Scores are then added to each other to obtain a score of the customer.

The “Credit Scoring” also describes the method.

When a scoring method using the technique is used, to improve score calculation precision, there is often employed a score calculation method in which the score card varies between customer data, that is, the same score card is not used for all customer data. A plurality of types of score cards are used according to a layer of a customer as an applicant to select an associated score calculation method according to, for example, “sex” and “region”.

JP-A-10-307808 describes a method of conducting sales prediction using scores.

In the prior art, although a score calculation method can be selected according to data values included in the customer data, the data values include wrong values intentionally supplied by customers and missing values in many case. In the method of selecting a score calculation method according to the data values specified by the customers, score calculation precision is considerably influenced by the data values.

According to the prior art, it is impossible to indicate important ones of the attributes used in the score calculation, and hence grounds of the score calculation cannot be presented to a person in charge of application decision.

### SUMMARY OF THE INVENTION

It is therefore an object of the present invention to provide a method of and a system for calculating scores in which a score calculation method can be selected for each customer from a plurality of score calculation methods for customer segments as applicants, without receiving influence of falsehood in data values of the customer data.

Another object of the present invention is to provide a method of and a system for calculating scores in which attributes of customer data used as grounds of the scoring can be presented.

To achieve the objects according to the present invention, there is provided a score calculation method hierarchically using prediction models to calculate a feature of a customer according to customer data. The method includes a step of calculating, according to a first-layer prediction model, an output value using input data including at least one attribute selected from attributes of the customer data, a step of selecting a prediction model of a subsequent layer according to the output value, and a step of repetitiously executing the output value calculating step and the prediction model of the subsequent layer until a prediction model to calculate scores of a customer of a lower-most layer is reached.

According to the present invention, the method may further includes a step of displaying input attributes of a prediction model of each layer, a step of counting the number of uses of an input attribute used as an input to a prediction model, and a step of calculating an importance degree of the attribute according to the number of uses.

### BRIEF DESCRIPTION OF THE DRAWINGS

The present invention will be more apparent from the following detailed description, when taken in conjunction with the accompanying drawings, in which:

FIG. 1 is a schematic diagram showing an example of a layout of data in an embodiment;

FIG. 2 is a diagram showing a configuration of a prediction model in an embodiment;

FIG. 3 is a diagram showing a score calculating unit in an embodiment of the present invention;

FIG. 4 is a flowchart showing a processing procedure of a score calculation method in an embodiment of the present invention;

FIG. 5 is a diagram showing an example of a layout of a score calculation model switch table in an embodiment of the present invention;

FIG. 6 is a diagram showing an attribute predicted value/score display screen in an embodiment of the present invention;

FIG. 7 is a diagram showing an attribute importance degree display screen in an embodiment of the present invention;

FIG. 8 is a diagram showing a score display screen in an embodiment of the present invention;

FIG. 9 is a diagram showing an overall construction of a score calculation system in a second embodiment of the present invention; and

FIG. 10 a flowchart showing a processing procedure of a score calculation method in a second embodiment of the present invention.

### DESCRIPTION OF THE EMBODIMENTS

Description will now be given of an embodiment of the present invention.

In the present invention, a lower-most layer which produces a final output is called “scoring layer” and the other layers are called “selecting layers”. Prediction models of the present invention are a scoring model to produce scores as output values and an attribute prediction model to produce predicted values of attributes.

The scoring model is a function of the input value and produces an output value such as a real number equal to or more than one or an integer equal to or more than one.

The attribute prediction model is also a function of the input value and calculates a value for an attribute valve as its predicted value. For example, for the attribute prediction model for predicting of “yearly income”, the output value is an integer of 5,000,000 (yen) and for the attribute prediction model for predicting “residence type”, the output value is a symbol value indicative of a rented house, an own house, or the like.

In a scoring method of the present invention, the final output value must be score. Therefore, a scoring model is used for the scoring layer and a scoring model or an attribute prediction model is used for selecting layers.

In this example, a scoring device is installed in, for example, a company associated with a financial firm to score an applicant for credit card application authorization. For an applicant, a clerk in charge of application authorization operates the scoring device to obtain a score of the applicant. According to the score, the clerk determines that the application is accepted or rejected.

Description will now be given of customer data and a prediction model used in each embodiment of the present invention.

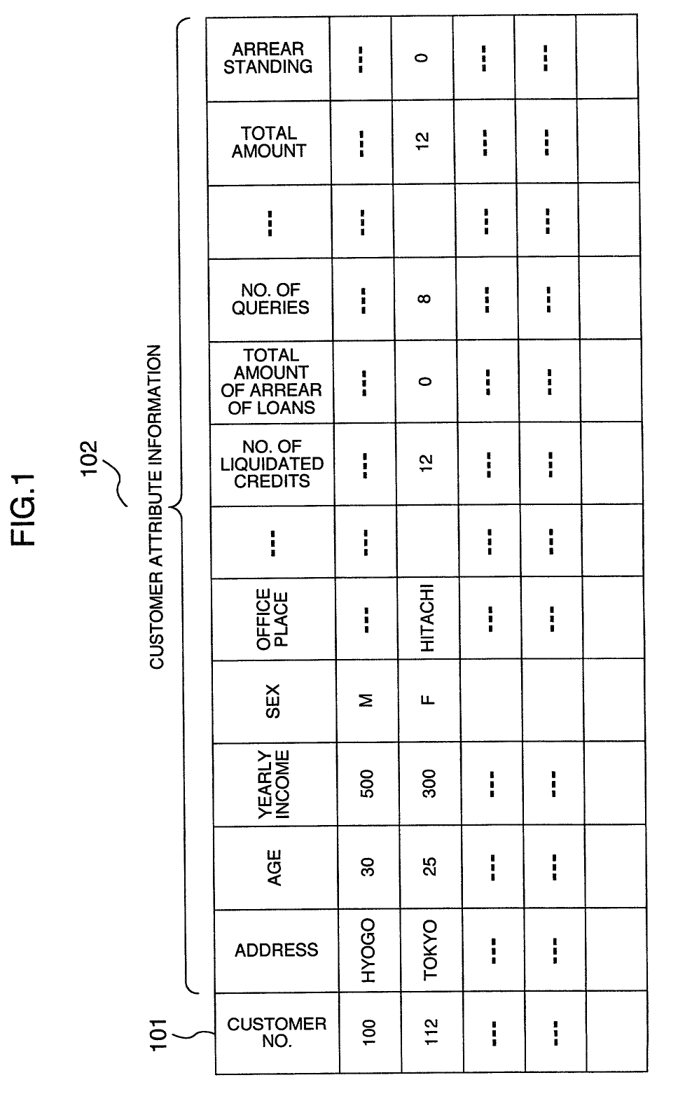

FIG. 1 shows an example of a layout of customer data used by the scoring device. This example is customer data for authorization of credit card application.

As shown in FIG. 1, the customer table is ordered in a table including one record for each customer. The record includes description of a customer number 101 and customer attribute information 102. The customer number 101 is an identification number to uniquely identify a customer. The customer attribute information 102 includes customer attribute information described on an application form by the customer, personal credit information collected from, for example, an external credit information center, and behavior history after authorization. The customer attribute information 102 is used as input data to the scoring device.

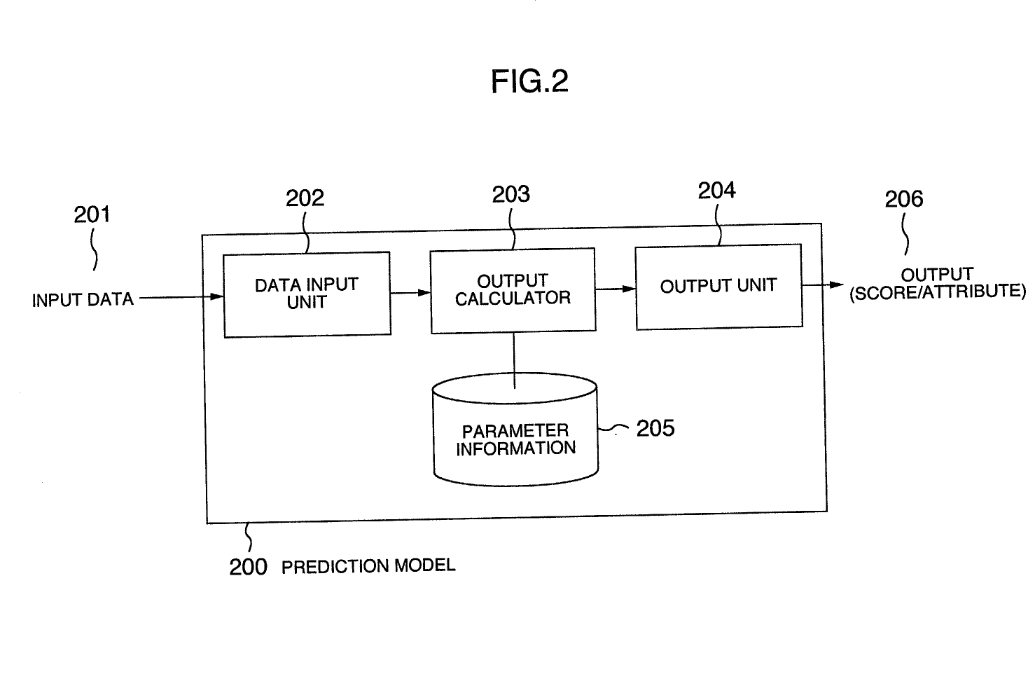

FIG. 2 shows structure of a prediction model 200 in the embodiment.

As can be seen from FIG. 2, the model 200 includes a data input processing unit 202, an output value calculating unit 203, an output value output unit 204, and parameter information 205.

The constituent components are implemented by software programs and/or tables in a memory of a computer.

The data input unit 202 receives as input data 201 several attributes contained in customer attribute information.

The parameter information 205 is information regarding a method of calculating an output value, for example, is a weight value corresponding to an attribute of an input item. When score cards are used, the parameter information 205 is stored, for example, in a table format including information items of categories of each attribute and scores or points assigned to each category.

The output calculating unit 203 calculates an output value using the input data 201 and the parameter information 205 in a predetermined calculation procedure. For example, for the score card, the scores of the respective categories of each item in the input data 201 are added to each other to obtain a total thereof as an output value.

The output unit 204 converts the output value into screen data, a file, or communication data and output the result therefrom.

In the embodiment, the prediction model includes two kinds of models having mutually different output values, namely, a scoring model and an attribute prediction model. The scoring model receives as input data 201 data including a combination of attributes selected from the customer attribute information and executes predetermined arithmetic processing to produce a score for decision to accept or to reject the application.

The scoring model includes, for example, a scoring expression

score=w1*x1+w2*x2+w3*x3+ (1)

where, x1 to x3 are values indicating an age, a yearly income, and a sex (1 for male and 2 for female), respectively. Parameters wi (i=1, 2, 3, etc.) are weights for respective attributes. For attributes of symbolical values such as the sex, numeric values are beforehand assigned to respective symbolical values. In the scoring, each symbolical value is converted into the associated numeric value.

Other examples include the score card of the prior art.

The attribute prediction model receives, as input data 201, several attributes from the customer attribute information and predicts a value of an attribute not including in the input data 201 to output the value therefrom. In an example of the attribute prediction model, data including information of “age”, “sex”, and “office address” is received as input data to produce a residence type as an output value.

The attribute prediction model includes an attribute predicting expression for a symbolical value attribute, for example, as below.

y=w1*x1+w2*x2+w3*x3+ (2)

where, x1 to x3 and w1, w2, w3 . . . are the same as those of expression (1);

0<=y<θ1 rented house

θ1<=y<θ2 own house;

θ1 and θ2 are values of boundaries to classify symbolical values.

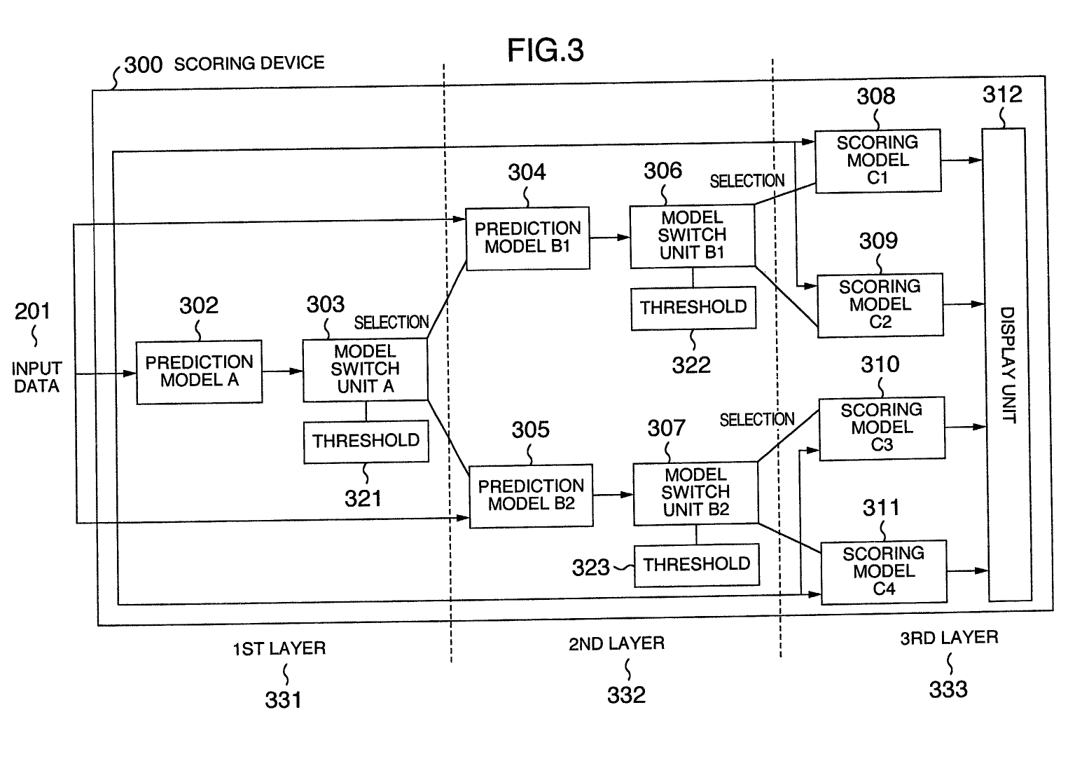

FIG. 3 shows constitution of a scoring device 300.

As shown in FIG. 3, the scoring device 300 includes prediction models 302, 304, and 305, model switch units 303, 306, and 307, threshold values 321 to 323, scoring models 308 to 311, and a display unit 312.

The scoring device 300 includes at least one computer and the models and the units are implemented by software programs. The prediction models 302, 304, and 305 and the scoring models 308 to 311 are constructed in the same way as for the prediction models described in conjunction with FIG. 2.

The scoring device 300 of the embodiment includes the prediction models of FIG. 2 arranged in three layers. That is, the prediction model 302 is disposed in a first layer 331, the prediction model 304 is arranged in a second layer 332, and the scoring models 308 to 311 are disposed in a third layer 333. Since an output value from the third layer 333 is an output from the scoring device 300, each prediction model in the third layer 333 is always a scoring model. In the embodiment, the prediction models in the first and second layers 331 and 332 are also scoring models. In the description below, a lower-most layer producing an output value which is an output from the scoring device 300 is called a scoring layer and any layers other than the scoring layer are called selecting layers. Therefore, the first and second layers 331 and 332 are selecting layers and the third layer 333 is a scoring layer.

The input data 201 is data including a combination of attributes of the customer attribute information and is used as input data to each prediction model. The input data may include different attributes for respective prediction models.

Prediction model A 302 calculates a score using the input data 201. Processing of prediction model A 302 is almost the same as that of the other prediction models 304 and 305 in the scoring device 300.

Model switch unit A 303 compares an output value from scoring model A 302 with the threshold value 321 to determine a prediction model to be adopted in a second layer. The threshold value 321 is beforehand set to be stored in a database or a file. The model switch units 306 and 307 in the second layer also execute the same processing as that of the model switch unit 303.

The scoring models 308 to 311 in the third layer transfer calculated scores to the display unit 312. The unit 312 displays the scores.

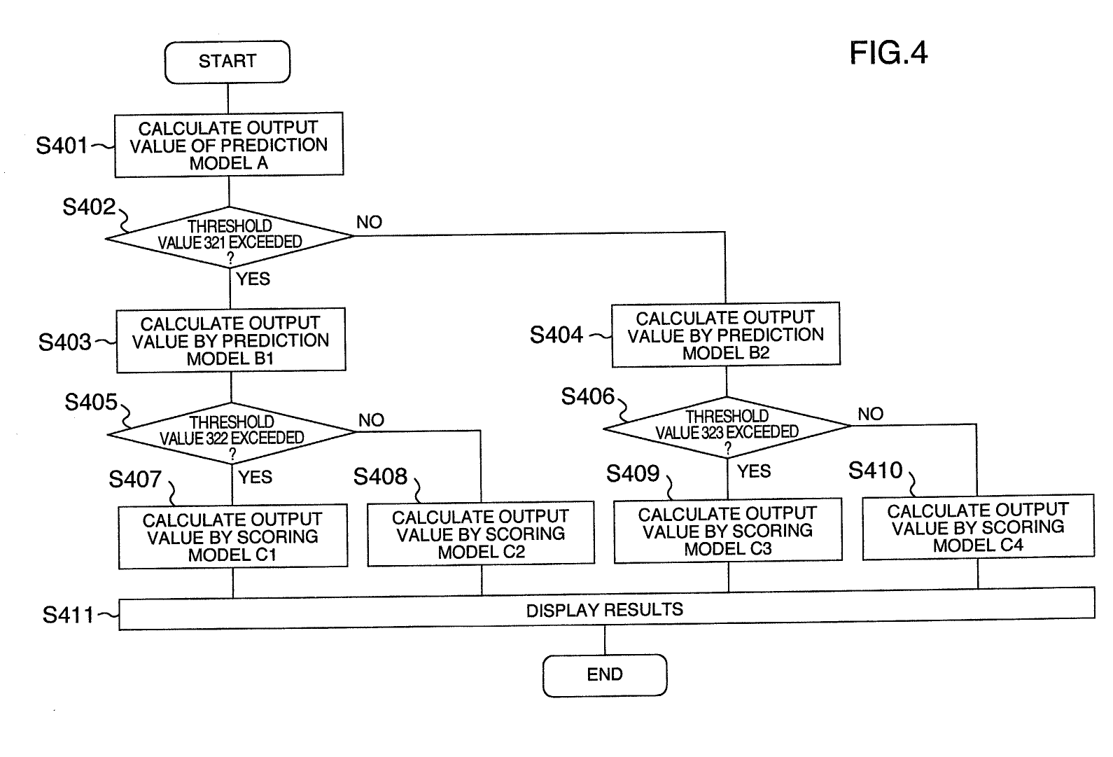

Referring now to FIG. 4, description will be given of a processing procedure of a scoring method in the embodiment.

In the embodiment, the score is a real number equal to or more than zero and equal to or less than one. When the score is nearer to one, it is more strongly indicated that the application is to be rejected.

In the flowchart of FIG. 4, scoring model a 302 calculates a score using necessary attributes of the input data 201 (step 401).

The program then compares an output value of step 401 with the threshold value 321. If the output value is equal to or more than the threshold value 321, processing goes to step 403; otherwise, processing goes to step 404 (step 402). Assume that the output value of step 401 is 0.6 and the threshold value is 0.5, processing goes to step 403 to use scoring model B1.

Scoring model B1 also calculates a score using necessary attributes of the input data 201 (step 403).

The program then compares an output value of step 403 with the threshold value 322. If the output value is equal to or more than the threshold value 322, processing goes to step 407. Otherwise, processing goes to step 408 (step 405). Assume that the output value of step 403 is 0.7 and the threshold value is 0.8, processing goes to step 408 to use scoring model C2.

Scoring model C2 calculates a score using necessary attributes of the input data 201 (step 408).

Finally, the score obtained in step 408 is displayed (step 411).

Although the embodiment includes a 3-layer configuration as an example, it is possible to employ a configuration including one or more selecting layers and one scoring layer.

In the embodiment, a scoring model is used as a prediction model in the selecting layer in the scoring device 300. However, an attribute prediction model may be employed as the prediction model in the selection layer. In this situation, for example, prediction model A 302 outputs a value of “yearly income” and prediction model B1 304 outputs a value of “age”.

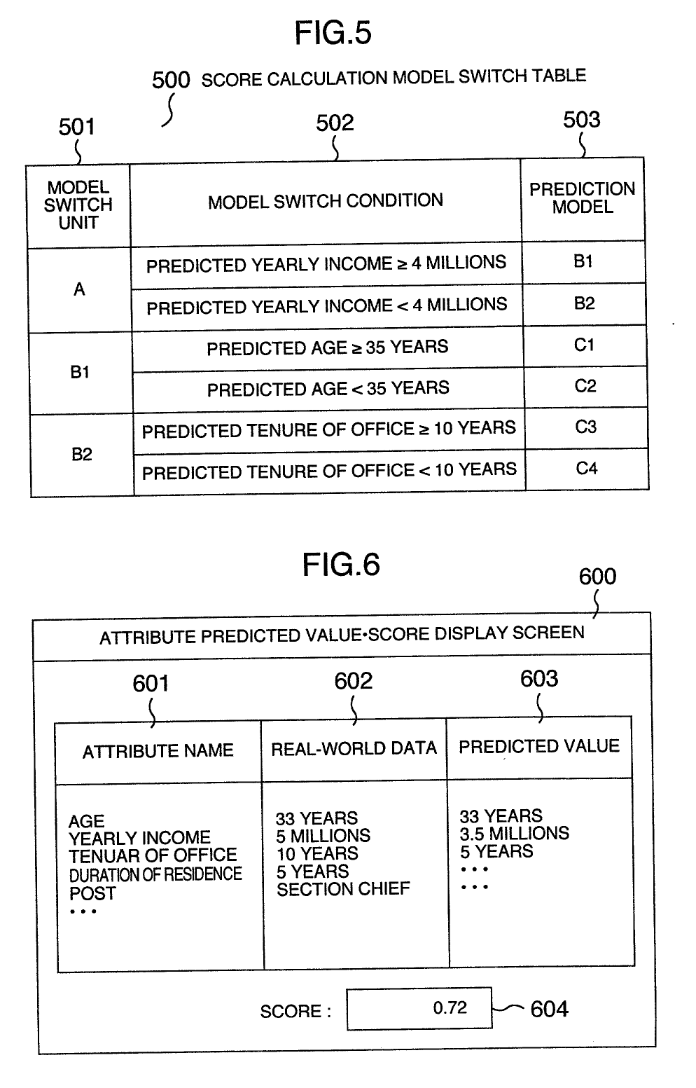

In the configuration, a threshold value is stored in each model switch means, it may also possible that information regarding the threshold values is managed in a concentrated manner using a scoring model switch table 500 as shown in FIG. 5. When the table is used, model switch unit A 303 makes a search through the table 500 for a model switch unit 501 and an associated model switch condition 502 to resultantly determine a prediction model 503 to be used in a subsequent layer.

In the configuration of the embodiment, a threshold value is stored in each model switch means. However, when the selection layout outputs symbolical values in the attribute prediction model, the model switch may be carried out using the symbolical values.

In the example, the score from the scoring model in the scoring layer is displayed so that the person in charge of application authorization determines that the application of the applicant is to be accepted or rejected according to the score. However, a unit to automatically determine acceptance or rejection of the application according to threshold values may be arranged. A unit to determine a credit line for a credit card may be provided.

Additionally, although the model switch unit selects either one of two prediction models according to a threshold value, the threshold may be set to two or more intervals to select two or more prediction models.

The model switch unit selects either one of the prediction models in the lower layer in the example. However, a result of the switching operation of the model switch unit may be used as an output of the scoring device.

Two or more model switch units may be connected to one prediction model in a lower layer.

In the example of the embodiment, the selection layer includes the same types of prediction models. However, a scoring model and an attribute prediction model may be included in the selection layer.

The input data 201 may be data received via a network such as the internet from another computer. The scoring device 300 calculates a score using the data. Information items such as the score, prediction models used in respective layers, data attributes used in the respective prediction models, output values from the respective prediction models may be transmitted via the internet to the communicating computer.

Description will next be given of a display example according to the present invention.

The display example is achieved in the scoring device 300 using an attribute prediction model as the prediction model in the selection layer (FIG. 3). Specifically, the display unit 312 of the device 300 presents data items on an attribute predicted value/score display screen 600 for the user.

As can be seen from FIG. 6, the display screen 600 shows fields of which each includes an item name 601, real-world data 602, a predicted value 603, and a score 604. The item name 601 is an item as an output value from an attribute prediction model in the selection layer. The real-world data 602 is a value of the customer attribute information. The predicted value 603 is an output value from the attribute prediction model. The score 604 is an output value calculated by the scoring device 300.

Even if attribute information is supplied from a customer, the information may be incorrect depending on cases. For example, a value of an information item is beyond or below an allowed range. In the situation, the system need not use the information specified by the user, namely, the real-world data. That is, in place thereof, the system may use, in place of the real-world data, other attribute information to calculate an appropriate value by an attribute prediction model. The value is employed as an input value to another model.

As above, by visually checking the input data, i.e., the real-world data of customer attribute information and the predicted value displayed on one screen image, the person in charge of authorization knows attributes used by the scoring device 300 to predict the score. For example, it can be known from the example of FIG. 6 that for five million Yen of the real-world data of “yearly income” of an applicant, the scoring device 300 predicted that his or her yearly income should be 3.5 million Yen according to other customer attribute information.

Description will be given of another display example according to the present invention.

The display example relates to a display method and a calculation method of an importance degree for an attribute of input data in the scoring device 300.

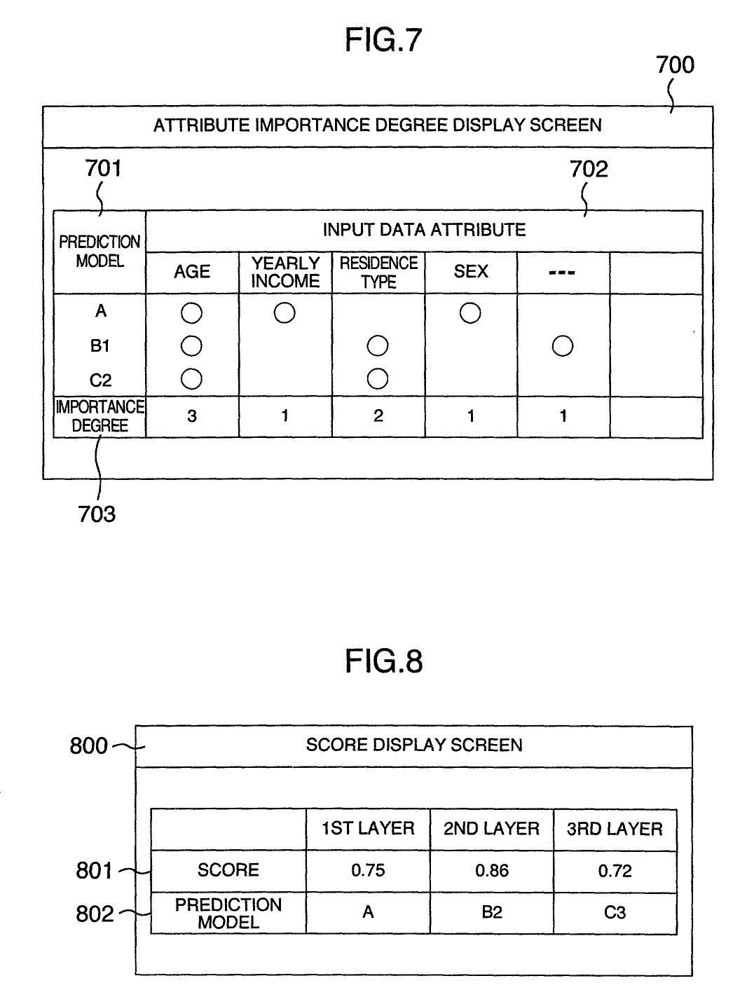

FIG. 7 shows an attribute importance degree display screen 700 presented for the user by the display unit 312 of the scoring device 300.

As shown in FIG. 7, the screen 700 includes fields of which each includes a prediction model 701, an input data attribute 702, and an importance degree. The prediction model 701 is a prediction model in a selection layer or a scoring layer selected according to input data of an applicant. The input data attribute 702 is an input data attribute used by a prediction model in each layer. A small circle indicates an associated input data attribute. The importance degree 703 is an importance degree for each input data attribute.

In the example shown in FIG. 7, prediction model A 302, prediction model B1 304, and scoring model C2 309 are selected for input data 201 of an applicant. In prediction model A 302, “age”, “yearly income”, “sex”, etc. are used as input data attributes. Similarly, prediction model B1 304 uses “age”, “residence type”, etc. as input data attributes and scoring model C2 309 uses “age”, “residence type”, etc. as input data attributes. In the example, “age” is used in prediction models A (302) and B1 (304) and scoring model C2 (309) and hence can be regarded important in the authorization of the applicant. According to the idea above, the number of uses if a selected prediction model is defined as an importance degree of the pertinent input data attribute. Therefore, “age” has an importance degree of “3” in this example. Similarly, “yearly income” and “residence type” have importance degree values of “1” and “2”, respectively. This indicates that “age” most contributes to the scoring among the three attributes “age”, “yearly income” and “residence type”.

As described above, the system displays utilization or non-utilization and an importance degree for each input data attribute in each prediction model. By visually checking the displayed items, the person in charge of authorization knows which ones of the attributes are important in the scoring.

For example, it is possible to extract customer data having the same the score and the different importance degree values of a particular attribute. By comparing the data with a result of each prediction (to determine whether or not a rejection results), information can be fed back to the selection of attributes for the scoring model. For example, for the customers with a low score, e.g., a score of 0.2 or less and a high importance degree of “residence type” and the customers with a low score, e.g., a score of 0.2 or less and a low importance degree of “residence type”, a ratio of cases of rejection is checked. If the ratio is higher for the customers a high importance degree of “residence type”, it can be considered that “residence type” contributes to precision of the prediction. Therefore, it would be advisable to introduce “residence type” also to a scoring model not using “residence type”. Conversely, If the ratio is higher for the customers a low importance degree of “residence type”, “residence type” need not be used by the scoring mode.

The importance degree is defined as the number of uses of an input data attribute in a selected prediction mode. However, the importance degree may be defined with a weight for each layer. For example, a value twice as much as that used in the selection layer may be added to an input data attribute used in the scoring layer.

It is also possible to extract customer data which has the same final score and for which different scoring models are used. By comparing results of respective predicted values, information can be fed back to select a combination (a hierarchical relationship between models and threshold values of respective models) of scoring models employed in the selecting layer.

Description will next be given of still another display example according to the present invention.

In the display example, a scoring model is used as the prediction model in the selecting layer.

FIG. 8 shows a score display screen 800 presented for the user by the display unit 312 of the scoring device 300.

As can be seen from FIG. 8, the screen 800 includes fields each of which including a score 801 and a prediction model 802 in a prediction model used in each layer. In the example of FIG. 8, scoring model A 302 in the first layer results in a score of 0.75, scoring model B2 305 in the second layer results in a score of 0.86, and scoring model C3 310 in the third layer results in a score of 0.72.

In the embodiment described above, in addition to a score outputted from the scoring device 300, a scoring model used in the selection layer and a score outputted from the scoring model are displayed. Therefore, the person in charge of authorization can understand a process used by the scoring device 300 to calculate the score.

Description will be given of a second embodiment of the present invention.

The embodiment relates to a method in which a plurality of prediction models disposed in one computer in the first embodiment are distributed to a plurality of computers connected via a network to each other to thereby increase the scoring speed.

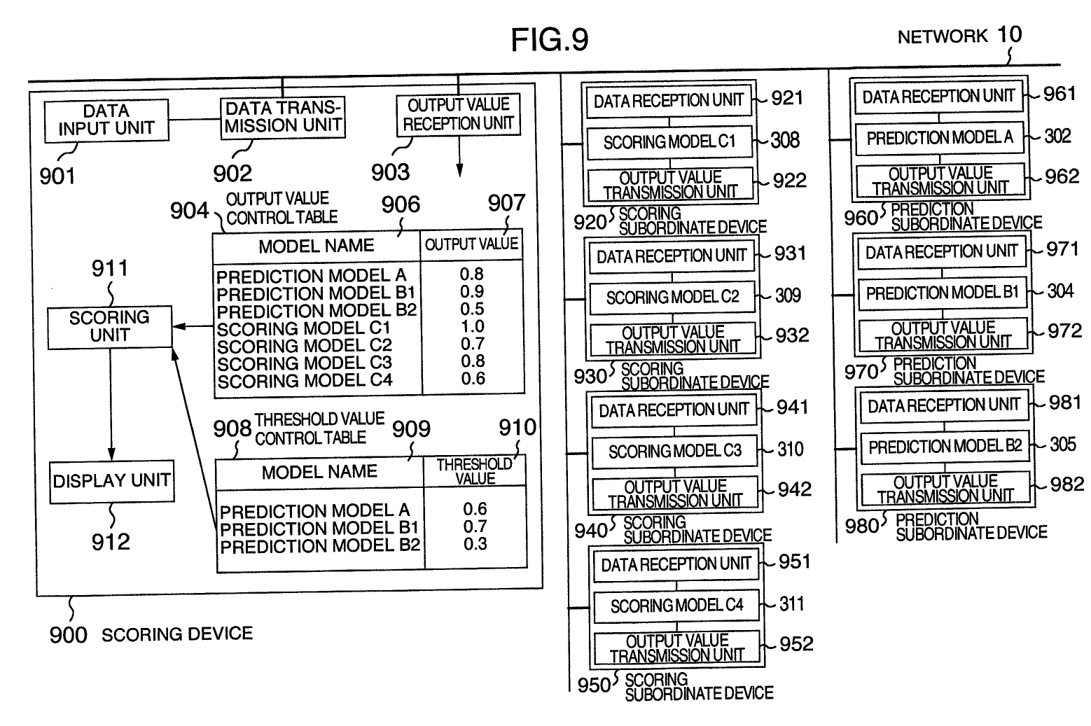

FIG. 9 shows a configuration of a second embodiment of a scoring system.

As shown in FIG. 9, the scoring system includes a scoring device 900, scoring subordinate devices 920, 930, 940, and 950, prediction subordinate devices 960, 970, and 980, and a network 10 to establish connections therebetween.

The scoring subordinate device corresponds to the scoring model of FIG. 3 and the prediction subordinate device corresponds to the prediction model of FIG. 3.

In primary operation, the scoring device 900 issues a request for calculation via the network 10 to the scoring subordinate devices 920, 930, 940, and 950 and the prediction subordinate devices 960, 970, and 980. Having received results of calculation from the devices, the scoring device 900 totals the results to obtain scores and displays the scores.

The scoring device 900 includes a data transmission unit 902 to send input data to the scoring subordinate devices and the prediction subordinate devices, an output value reception unit 903 to receive output values from the scoring subordinate devices and the prediction subordinate devices, an output value control table 904 to store the output values received by the reception unit 903, a threshold value control table 908, a scoring unit 911 to calculate scores using data stored in the output value control table 904 and data stored in the threshold value control table 908, and a display unit 912 to display the scores calculated by the scoring unit 911.

The scoring subordinate device 920 primarily executes processing to calculate scores and includes a data reception unit 921, a scoring model C1 308, and an output value transmission unit 922. Data received by the data reception unit 921 is fed to the scoring model 1l 308 to calculate scores. The output value transmission unit 922 sends the scores via the network 10 to the scoring device 900. The scoring subordinate devices 930, 940, and 950 conduct processing similar to that of the scoring subordinate device 920.

The prediction subordinate device 960 includes a data reception unit 961, a prediction model A 302, and an output value transmission unit 962. Data received by the data reception unit 961 is delivered to the prediction model A 302 to calculate output values. The output transmission unit 962 transmits the output values via the network to the scoring device 900. The prediction subordinate devices 970 and 980 conduct processing similar to that of the prediction subordinate device 960.

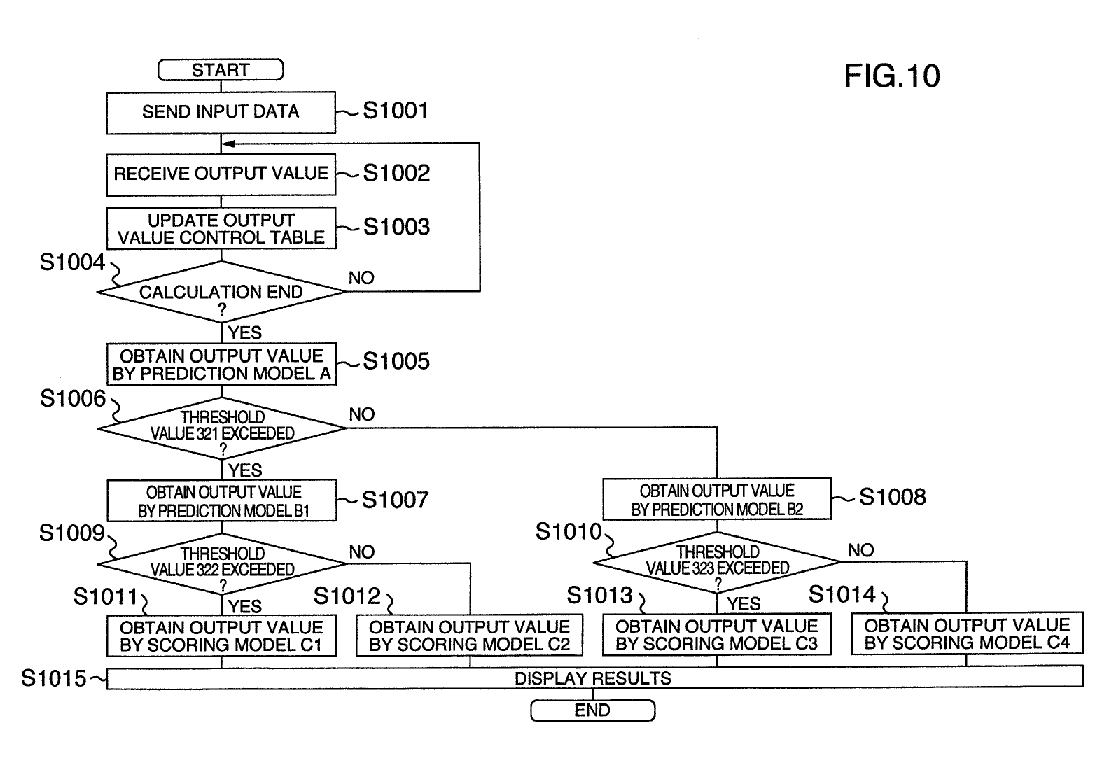

FIG. 10 shows a processing procedure to calculate scores in the scoring device 900 in a flowchart.

As can be seen from the flowchart of the scoring device 900, when input data is received via the data input unit 901, the data transmission unit 902 sends the input data via the network 10 to the scoring subordinate devices and the prediction subordinate devices (step 1001).

Each scoring subordinate device and each prediction subordinate device sends results of calculation to the output value reception unit 903. On receiving the output values (step 1002), the unit 903 stores the output values in the output value control table 904 (step 1003).

Whether or not the calculation is completely finished by the scoring subordinate devices and the prediction subordinate devices is checked according to the output value control table 904. If the calculation has not been completely finished, processing returns to step 1002 (step 1004).

If the calculation has been completely finished, the scoring unit 911 calculates a score. The unit 911 receives an output value of the prediction model A from the output value control table 904. The unit 911 then receives a threshold value of the prediction model A from the threshold value control table 908 to determine whether or not the output value is equal to or more than the threshold value. If the output value is equal to or more than the threshold value, processing goes to step 1007; otherwise, processing goes to step 1008. Similarly, processing goes to either one of steps 1011 to 1014.

Finally, the display unit 912 displays the scores (step 1015).

In the embodiment described above, the scoring devices are connected via a network to each other in a distributed configuration to concurrently execute scoring processing. This increases the overall calculation speed.

In the example, when the calculation is completely finished in the scoring subordinate devices and the prediction subordinate devices, the scoring unit 911 starts its processing. However, it is also possible that when an output value of the prediction model A is received, the processing of step 1005 is immediately executed without waiting for other calculation results. Similarly, processing may go to step 1007 or 1008 only if step 1005 is finished.

Although one prediction model is allocated to one computer in the constitution of the embodiment, a plurality of prediction models may be installed in one computer.

A unit including a prediction model may be shared between a plurality of scoring devices.

In the example of the embodiment, the threshold value employed for the model switching is a numeric value. However, when an attribute prediction model in which the output value of the selection layer is a symbolical value is used, the model switching may be carried out using a symbolical value.

A program to execute the scoring method of the present invention may be stored on a storing medium so that the program is read in a memory for execution thereof.

The specification and drawings are, accordingly, to be regarded in an illustrative rather than a restrictive sense. It will, however, be evident that various modifications and changes may be made thereto without departing from the broader spirit and scope of the invention as set forth in the claims.

What is claimed is:

1. A score calculation method of calculating a score using data, comprising the steps of:
disposing a plurality of layers and preparing a prediction model for each of the layers to calculate a feature;
calculating, according to a prediction model in a first layer, an output value using input data including at least one attribute selected from attributes of the data;
selecting a prediction model in a subsequent layer according to the output value;
repetitiously executing the output value calculation step and the subsequent layer prediction model selection step until a prediction model of a final layer is reached; and
calculating a score using the prediction model in the final model.

2. A score calculation method according to claim 1, wherein the prediction model includes:
a scoring model to calculate a score using attributes of the input data; and
an attribute prediction model to predict, using attributes of the input data, a value of another attribute.

3. A score calculation method according to claim 2, wherein the prediction model in the final layer is a scoring model.

4. A score calculation method according to claim 1, wherein said selection of a prediction model in a subsequent layer is determined according to the output value and at least one threshold value.

5. A score calculation method according to claim 1, wherein said selection of a prediction model in a subsequent layer is determined according to the output value and a category to which the output value belongs.

6. A score calculation method according to claim 1, further comprising the step of displaying a number of uses of an attribute used in the all layers.

7. A score calculation method according to claim 1, further comprising the step of displaying prediction models used in the layers and output values thereof.

8. A score calculation system for calculating a score using data, comprising:
a prediction model to calculate a feature in each of a plurality of layers;
selecting means for selecting the prediction model in a subsequent layer; and
display means for displaying a score, wherein
a prediction model in an N-th layer (N>=1) calculates an output value using input data including at least one attribute selected from attributes of the data,
said selecting means selects a prediction model in a subsequent layer according to the output value, and
said display means displays a score including an output from said prediction model.

9. A score calculation system according to claim 8, wherein said prediction model and said selecting means are implemented respectively by different computers.

10. A score calculation system according to claim 8, wherein said prediction models are executed by a plurality of computers.

11. A program for calculating a score using data, comprising the codes to executes the steps of:
disposing a plurality of layers and preparing a prediction model for each of the layers to calculate a feature;
calculating, according to a prediction model in a first layer, an output value using input data including at least one attribute selected from attributes of the data;
selecting a prediction model in a subsequent layer according to the output value;
repetitiously executing the output value calculation step and the subsequent layer prediction model selection step until a prediction model of a final layer is reached; and
calculating a score using the prediction model in the final model.
